(19) United States
(12) Patent Application Publication
(10) Pub. No.: US 2026/0341248 A1
(43) Pub. Date: Oct. 29, 2026

(54) DISPLAYPORT CONVERSION DEVICE AND OPERATION METHOD THEREOF

(71) Applicant: VIA LABS, INC., New Taipei City (TW)

(72) Inventor: Yun-Tien Liu, New Taipei City (TW)

(73) Assignee: VIA LABS, INC., New Taipei City (TW)

(21) Appl. No.: 19/322,726

(22) Filed: Sep. 9, 2025

(30) Foreign Application Priority Data
Apr. 28, 2025 (TW) 114115887

(51) Int. Cl. G09G 5/00; H04N 19/44; H04N 21/43; H04N 21/44

(52) U.S. Cl. CPC G09G 5/008; H04N 19/44; H04N 21/4305; H04N 21/44004; G09G 2370/10

(57) ABSTRACT

A DisplayPort conversion device and an operation method thereof are provided. The DisplayPort conversion device includes a decoding circuit, a detection circuit, and a speed compensation circuit. The decoding circuit decodes an input data stream to generate a DisplayPort signal stream. The detection circuit detects a first target content in the input data stream. The detection circuit detects a second target content in the DisplayPort signal stream. The detection circuit measures a time difference between the first target content and the second target content. The speed compensation circuit adjusts an output speed of the DisplayPort signal stream of the decoding circuit based on the time difference.

### CROSS-REFERENCE TO RELATED APPLICATION

This application claims the priority benefit of Taiwan application serial no. 114115887, filed on Apr. 28, 2025. The entirety of the above-mentioned patent application is hereby incorporated by reference herein and made a part of this specification.

### BACKGROUND

### Technical Field

The disclosure relates to an electronic device, and in particular to a DisplayPort (DP) conversion device and an operation method thereof.

### Description of Related Art

Universal serial bus version 4 (USB4) specifies a tunneling mode to transmit non-USB data. For example, when different electronic devices use USB4 signals to transmit DisplayPort (DP) signals, a DP signal source device may transmit DP data to a DP signal receiving device through a USB4 channel.

FIG. 1 is a circuit block schematic diagram of a conventional universal serial bus (USB) system 100. The USB system 100 shown in FIG. 1 includes a USB host 110, a USB cable 120, and a USB device (or USB hub) 130. A DP source device 111 may serially transmit a DP signal to a DP receiving device 132 through the USB cable 120. During the transmission process, a DP in adapter (DPIA) 112 of the USB host 110 first converts a DP signal stream of the DP source device 111 into a USB data stream. Then, the DP in adapter 112 transmits the USB data stream to the USB device 130 through the USB cable 120. A DP out adapter (DPOA) 131 of the USB device 130 converts the USB data stream from the USB cable 120 back into the DP signal stream. Then, the DP out adapter 131 transmits the DP signal stream to the DP receiving device 132.

The DP in adapter 112 transmits USB data to the USB cable 120 based on an internal clock signal generated by a local clock generation circuit. The DP out adapter 131 transmits the DP signal to the DP receiving device 132 (for example, a display) based on the internal clock signal generated by the local clock generation circuit. Generally speaking, the output speed of the DP out adapter 131 matches the output speed of the DP in adapter 112. The DP in adapter 112 has a grant master timer, and the DP out adapter 131 also has a grant master timer. The DP in adapter 112 and the DP out adapter 131 each calculates a clock cycle number based on its own grant master timer. When the grant master timer of the DP out adapter 131 cannot operate normally for some reason, there may be a frequency deviation between the internal clock signal of the DP in adapter 112 and the internal clock signal of the DP out adapter 131, thereby causing data loss.

It should be noted that the content of the "Description of Related Art" section is used to help understand the disclosure. Some (or all) of the content disclosed in the "Description of Related Art" section may not be conventional art known to persons with ordinary skill in the art. The content disclosed in the "Description of Related Art" section does not mean that the content has been known to persons with ordinary skill in the art before the application of the disclosure.

### SUMMARY

The disclosure provides a DisplayPort (DP) conversion device and an operation method thereof to convert an input data stream into a DisplayPort signal stream.

In an embodiment of the disclosure, the DisplayPort conversion device includes a decoding circuit, a detection circuit, and a speed compensation circuit. The decoding circuit receives and decodes an input data stream to generate a DisplayPort signal stream. The detection circuit is coupled to an input terminal of the decoding circuit to receive the input data stream. The detection circuit is coupled to an output terminal of the decoding circuit to receive the DisplayPort signal stream. The detection circuit detects a first target content in the input data stream. The detection circuit detects a second target content in the DisplayPort signal stream. The detection circuit measures a time difference between the first target content and the second target content. The speed compensation circuit is coupled to the detection circuit to receive time difference information indicating the time difference. The speed compensation circuit adjusts an output speed of the DisplayPort signal stream of the decoding circuit based on the time difference.

In an embodiment of the disclosure, the operation method includes the following steps. An input data stream is received and decoded by a decoding circuit of a DisplayPort conversion device to generate a DisplayPort signal stream. A first target content in the input data stream is detected by a detection circuit. A second target content in the DisplayPort signal stream is detected by the detection circuit. A time difference between the first target content and the second target content is measured by the detection circuit. An output speed of the DisplayPort signal stream of the decoding circuit is adjusted based on the time difference by a speed compensation circuit.

Based on the above, the decoding circuit described in the embodiments of the disclosure converts the input data stream into the DisplayPort signal stream. The detection circuit detects the content of the input data stream and the content of the DisplayPort signal stream, thereby measuring the time difference between the input data stream and the DisplayPort signal stream. The speed compensation circuit adjusts the output speed of the DisplayPort signal stream of the decoding circuit based on the time difference. Therefore, the output speed of the decoding circuit may match the input speed of the decoding circuit. That is, in the case where the input data stream is from a certain remote device, the output speed of the decoding circuit may match the output speed of the remote device. Based on this, the DisplayPort conversion device may stably (without interruption) and faithfully (without omission) transmit received data to a post-stage device (for example, a display).

In order for the features and advantages of the disclosure to be more comprehensible, the following specific embodiments are described in detail in conjunction with the drawings.

### BRIEF DESCRIPTION OF THE DRAWINGS

FIG. 1 is a circuit block schematic diagram of a conventional universal serial bus (USB) system.

FIG. 2 is a circuit block schematic diagram of a DisplayPort (DP) conversion device according to an embodiment of the disclosure.

FIG. 3 is a flowchart of an operation method of a DP conversion device according to an embodiment of the disclosure.

FIG. 4 is a timing schematic diagram of a target content in an input data stream and a target content in a DP signal stream according to an embodiment of the disclosure.

FIG. 5 is a circuit block schematic diagram of a decoding circuit and a detection circuit according to an embodiment of the disclosure.

### DESCRIPTION OF THE EMBODIMENTS

The term "coupling (or connection)" used in the entire specification (including the claims) of the disclosure may refer to any direct or indirect connection means. For example, if a first device is described as being coupled (or connected) to a second device, it should be interpreted that the first device may be directly connected to the second device or the first device may be indirectly connected to the second device through another device or certain connection means. Terms such as "first" and "second" mentioned in the entire specification (including the claims) of the disclosure are used to name the elements or to distinguish between different embodiments or ranges, but not to limit the upper limit or the lower limit of the number of elements or to limit the sequence of the elements. In addition, wherever possible, elements/components/steps using the same reference numerals in the drawings and the implementation manners represent the same or similar parts. Related descriptions of the elements/components/steps using the same reference numerals or using the same terms in different embodiments may be cross-referenced.

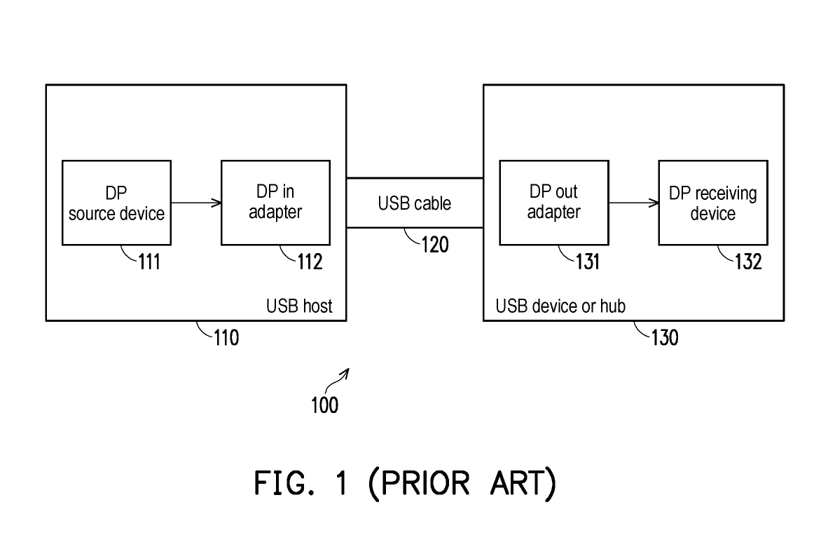

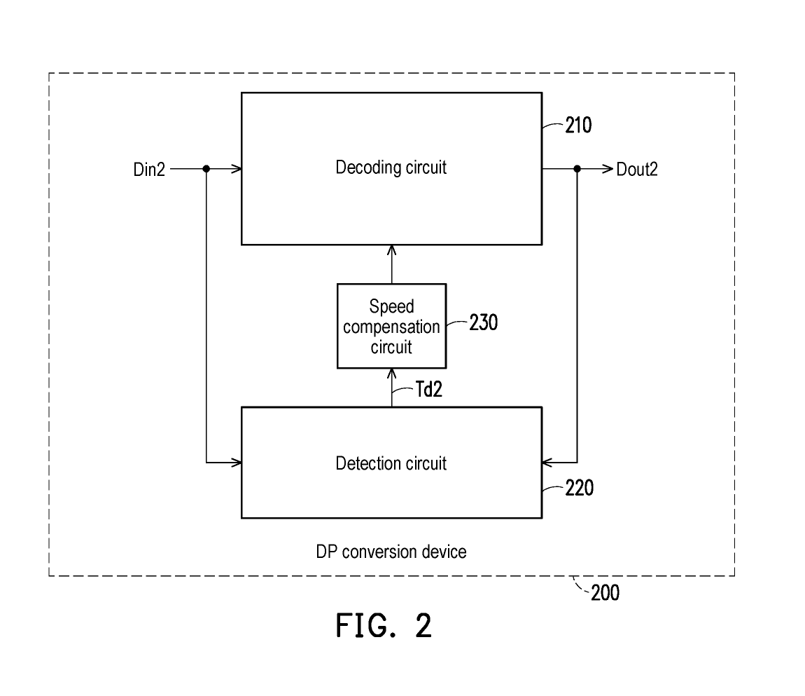

FIG. 2 is a circuit block schematic diagram of a DisplayPort (DP) conversion device 200 according to an embodiment of the disclosure. The DP conversion device 200 may convert an input data stream Din2 into a DP signal stream Dout2. Based on actual design and application, the input data stream Din2 may be a universal serial bus (USB) data stream, a DP data stream, or other data streams. For example, the DP conversion device 200 may be applied to the scenario shown in FIG. 1 and serve as the DP out adapter 131, but not limited thereto.

In the embodiment shown in FIG. 2, the DP conversion device 200 includes a decoding circuit 210, a detection circuit 220, and a speed compensation circuit 230. The decoding circuit 210 receives and decodes the input data stream Din2 to generate a DP signal stream Dout2. The detection circuit 220 is coupled to the input terminal of the decoding circuit 210 to receive the input data stream Din2. The detection circuit 220 is coupled to the output terminal of the decoding circuit 210 to receive the DP signal stream Dout2. The speed compensation circuit 230 is coupled to the detection circuit 220 to receive time difference information Td2, wherein the time difference information Td2 represents a time difference between the input data stream Din2 and the DP signal stream Dout2. According to different designs, in some embodiments, the decoding circuit 210, the detection circuit 220, and/or the speed compensation circuit 230 may be implemented as hardware circuits. In some other embodiments, the decoding circuit 210, the detection circuit 220, and/or the speed compensation circuit 230 may be implemented in a combination of multiple of the forms of hardware, firmware, and software (that is, program).

In terms of the form of hardware, the decoding circuit 210, the detection circuit 220, and/or the speed compensation circuit 230 may be implemented as logic circuits on an integrated circuit. For example, the relevant functions of the decoding circuit 210, the detection circuit 220, and/or the speed compensation circuit 230 may be implemented in various logic blocks, modules, and circuits in one or more hardware controllers, microcontrollers, hardware processors, microprocessors, application-specific integrated circuits (ASICs), digital signal processors (DSPs), field programmable gate arrays (FPGAs), central processing units (CPUs), and/or other processing units. The relevant functions of the decoding circuit 210, the detection circuit 220, and/or the speed compensation circuit 230 may be implemented in hardware circuits, such as various logic blocks, modules, and circuits in the integrated circuit, using hardware description languages (for example, Verilog HDL or VHDL) or other suitable programming languages.

In terms of the form of software and/or the form of firmware, the relevant functions of the decoding circuit 210, the detection circuit 220, and/or the speed compensation circuit 230 may be implemented as programming codes. For example, the decoding circuit 210, the detection circuit 220, and/or the speed compensation circuit 230 are implemented using general programming languages (for example, C, C++, or assembly languages) or other suitable programming languages. The programming codes may be recorded/stored in a “non-transitory machine-readable storage medium”. In some embodiments, the non-transitory machine-readable storage medium includes, for example, a semiconductor memory and/or a storage device. An electronic apparatus (for example, a CPU, a hardware controller, a microcontroller, a hardware processor, or a microprocessor) may read and execute the programming codes from the non-transitory machine-readable storage medium, thereby implementing the relevant functions of the decoding circuit 210, the detection circuit 220, and/or the speed compensation circuit 230.

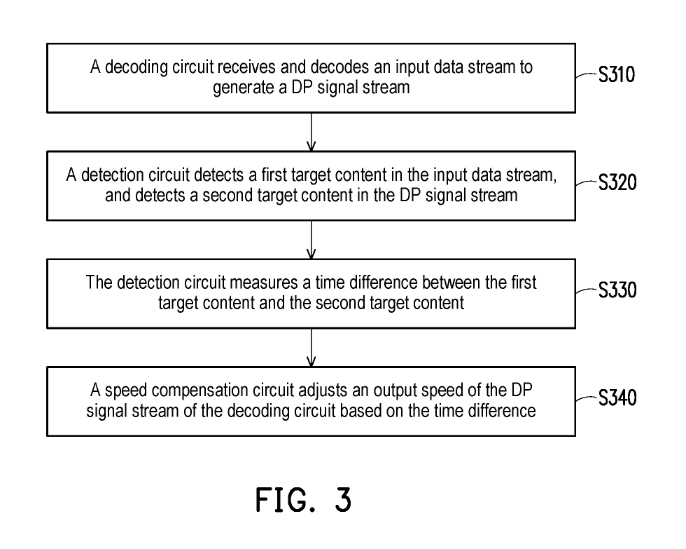

FIG. 3 is a flowchart of an operation method of a DisplayPort (DP) conversion device according to an embodiment of the disclosure. Please refer to FIG. 2 and FIG. 3. In step S310, the decoding circuit 210 receives and decodes the input data stream Din2 to generate the DP signal stream Dout2. For example, the decoding circuit 210 receives and decodes the input data stream Din2, and then stores a decoding result in a buffer (not shown in FIG. 2). The decoding circuit 210 converts the decoding result of the buffer into the DP signal stream Dout2 based on an internal clock signal generated by a local clock generator (not shown in FIG. 2), and transmits the DP signal stream Dout2 to a DP receiving device (not shown, for example, a display or other DP devices).

In step S320, the detection circuit 220 detects a target content (first target content) in the input data stream Din2, and the detection circuit 220 detects a target content (second target content) in the DP signal stream Dout2. The target content in the input data stream Din2 and the target content in the DP signal stream Dout2 may be defined according to actual design and application. For example, the target content in the input data stream Din2 and the target content in the DP signal stream Dout2 may include main stream attribute (MSA) data defined in the USB4 specification. In some embodiments, the target content may include any symbol in a control code (also referred to as a K-code) in the MSA data, such as a scrambler reset (SR) symbol or other symbols. The K-code is the control code for indicating the start of a row on a link layer.

In step S330, the detection circuit 220 measures a time difference between the target content in the input data stream Din2 and the target content in the DP signal stream Dout2 to generate the time difference information Td2 for indicating the time difference to the speed compensation circuit 230. For example, the target content detected in step S320 may be the SR symbol, but not limited thereto. The detection circuit 220 detects the SR symbol in the input data stream Din2, and the detection circuit 220 detects the SR symbol in the DP signal stream Dout2. The detection circuit 220 measures the time difference between the SR symbol in the input data stream Din2 and the SR symbol in the DP signal stream Dout2, and then outputs the time difference (time difference information Td2) to the speed compensation circuit 230.

In step S340, the speed compensation circuit 230 adjusts the output speed of the DP signal stream Dout2 of the decoding circuit 210 based on the time difference information Td2 (time difference). For example, the speed compensation circuit 230 may adjust the clock frequency of the clock generator (not shown in FIG. 2) of the decoding circuit 210 based on the time difference information Td2 to change the output speed of the DP signal stream Dout2.

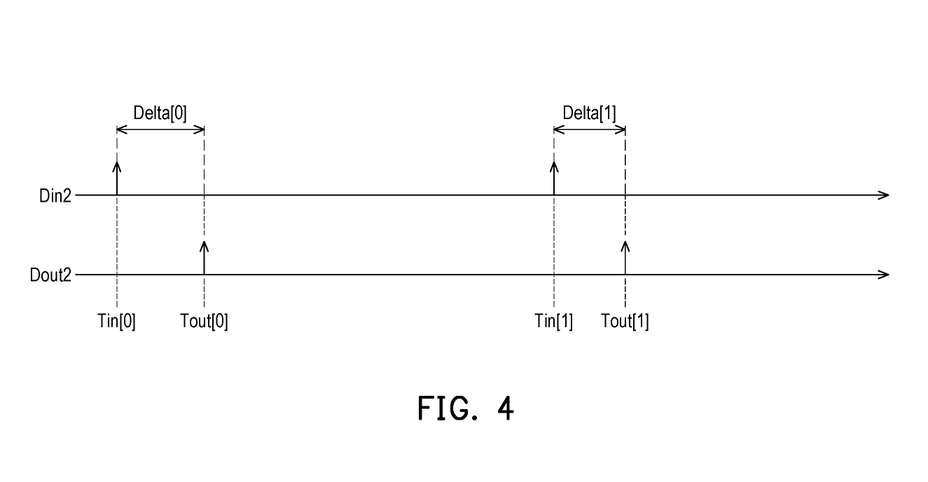

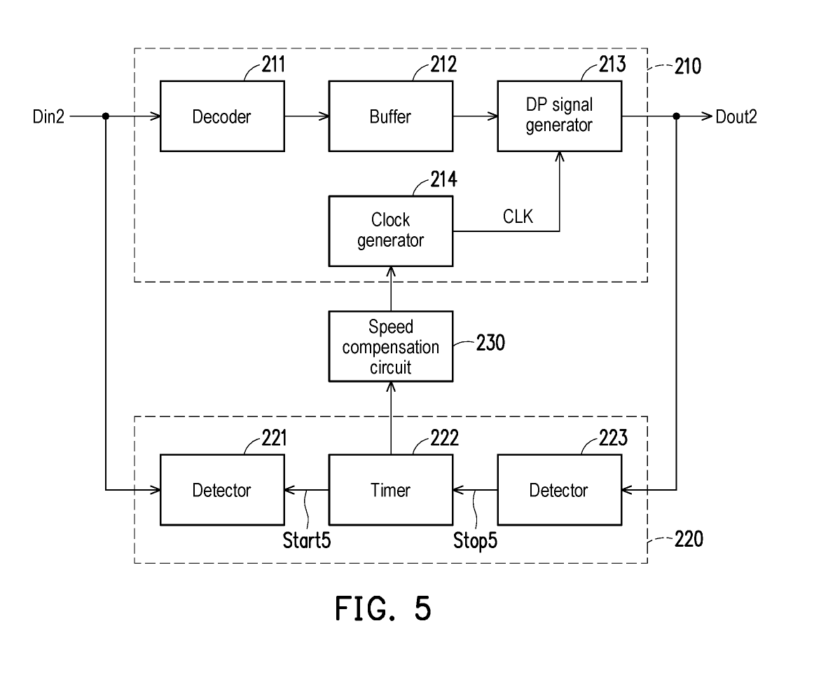

FIG. 4 is a timing schematic diagram of the target content in the input data stream Din2 and the target content in the DP signal stream Dout2 according to an embodiment of the disclosure. The horizontal axis of FIG. 4 represents time. Please refer to FIGS. 2 and 4. The target contents (for example, the SR symbols) appear multiple times in the input data stream Din2 and the DP signal stream Dout2. For example, the detection circuit 220 detects the target content from the input data stream Din2 at a time point Tin[0], and then detects the target content from the DP signal stream Dout2 at a time point Tout[0]. The detection circuit 220 measures a time difference Delta[0] between the target content in the input data stream Din2 and the target content in the DP signal stream Dout2, and then outputs the time difference Delta[0] (time difference information Td2) to the speed compensation circuit 230. If the target content of the input data stream Din2 at the time point Tin[0] is the first target content transmitted to the DP conversion device 200 by a certain remote device (not shown, for example, the USB host 110 shown in FIG. 1), the decoding circuit 210 may set the time difference Delta[0] to an accumulation cycle (AccCyc) number of the buffer (not shown, for example, a buffer 212 shown in FIG. 5) in the decoding circuit 210. AccCyc is defined in the USB4 specification, so there will be no reiteration.

By analogy, a time difference Delta[1] between a time point Tin[1] of a next target content in the input data stream Din2 and a time point Tout[1] of a next target content in the DP signal stream Dout2 is also output to the speed compensation circuit 230. The speed compensation circuit 230 adjusts the output speed of the DP signal stream Dout2 of the decoding circuit 210 based on the time difference Delta[1] (time difference information Td2). For example, the speed compensation circuit 230 compares the time difference Delta[1] with a certain reference time length to obtain a comparison result. The speed compensation circuit 230 adjusts the output speed of the DP signal stream Dout2 of the decoding circuit 210 in response to the comparison result.

For example, in response to the time difference Delta[1] being greater than the reference time length, the speed compensation circuit 230 speeds up the output speed of the DP signal stream Dout2 of the decoding circuit 210. In response to the time difference Delta[1] being less than the reference time length, the speed compensation circuit 230 slows down the output speed of the DP signal stream Dout2 of the decoding circuit 210. The reference time length may be defined according to actual design and application. For example, the reference time length includes the AccCyc number of the buffer (not shown) of the decoding circuit 210. When the time difference Delta[1] is greater than the AccCyc number, the speed compensation circuit 230 speeds up the output speed of the DP signal stream Dout2 of the decoding circuit 210 to shorten a time difference Delta[2] of a next target content (not shown in FIG. 4). When the time difference Delta[1] is less than the AccCyc number, the speed compensation circuit 230 slows down the output speed of the DP signal stream Dout2 of the decoding circuit 210 to lengthen the time difference Delta[2] of the next target content (not shown in FIG. 4).

For another example, the reference time length includes an initial time difference (a first time difference) generated in “detection operations of the input data stream Din2 and the DP signal stream Dout2”. Taking FIG. 4 as an example, if the target content of the input data stream Din2 at the time point Tin[0] is the first target content transmitted to the DP conversion device 200 by a certain remote device (not shown, for example, the USB host 110 shown in FIG. 1), the time difference Delta[0] is the initial time difference generated in the "detection operations of the input data stream Din2 and the DP signal stream Dout2". When the time difference Delta[1] is greater than the time difference Delta[0], the speed compensation circuit 230 speeds up the output speed of the DP signal stream Dout2 of the decoding circuit 210 to shorten the time difference Delta[2] of the next target content (not shown in FIG. 4). When the time difference Delta[1] is less than the time difference Delta[0], the speed compensation circuit 230 slows down the output speed of the DP signal stream Dout2 of the decoding circuit 210 to lengthen the time difference Delta[2] of the next target content (not shown in FIG. 4).

In summary, the decoding circuit 210 converts the input data stream Din2 into the DP signal stream Dout2. The detection circuit 220 detects the content of the input data stream Din2 and the content of the DP signal stream Dout2, thereby measuring the time difference (for example, the time difference Delta[1] shown in FIG. 4) between the input data stream Din2 and the DP signal stream Dout2. The speed compensation circuit 230 adjusts the output speed of the DP signal stream Dout2 of the decoding circuit 210 based on the time difference Delta[1]. Therefore, the output speed of the decoding circuit 210 may match the input speed of the decoding circuit 210. That is, in the case where the input data stream Din2 is from a certain remote device (not shown, for example, the USB host 110 shown in FIG. 1), the output speed of the decoding circuit 210 may match the output speed of the remote device. Based on this, the DP conversion device 200 may stably (without interruption) and faithfully (without omission) transmit received data to a post-stage device (not shown, for example, a display or other DP devices).

FIG. 5 is a circuit block schematic diagram of the decoding circuit 210 and the detection circuit 220 according to an embodiment of the disclosure. The decoding circuit 210 and the detection circuit 220 shown in FIG. 5 may be used as one of many implementation examples of the decoding circuit 210 and the detection circuit 220 shown in FIG. 2. Reference may be made to the relevant descriptions of FIGS. 2-4 for the input data stream Din2, the DP signal stream Dout2, the decoding circuit 210, the detection circuit 220, and the speed compensation circuit 230 shown in FIG. 5.

In the embodiment shown in FIG. 5, the detection circuit 220 includes a detector 221, a timer 222, and a detector 223. The detector 221 is coupled to the input terminal of the decoding circuit 210 to receive the input data stream Din2. The detector 221 detects the target content (for example, the SR symbol or other recognizable messages) in the input data stream Din2. In response to the detector 221 detecting the target content, the detector 221 sends a timing start signal Start5 to the timer 222. The detector 223 is coupled to the output terminal of the decoding circuit 210 to receive the DP signal stream Dout2. The detector 223 detects the target content (for example, the SR symbol or other recognizable messages) in the DP signal stream Dout2. In response to the detector 223 detecting the target content, the detector 223 sends a timing stop signal Stop5 to the timer 222. The embodiment does not limit the specific implementations of the detector 221 and the detector 223. For example, in the implementation example taking the SR symbol as the target content, the detector 221 and the detector 223 may include conventional SR symbol detectors or other detectors.

The timer 222 is coupled to the speed compensation circuit 230, the detector 221, and the detector 223. In response to the detector 221 detecting the target content (the timing start signal Start5 is true), the timer 222 starts timing from an initial value. The initial value may be defined according to actual design and application. For example, the initial value is "0" or other values. In response to the detector 223 detecting the target content (the timing stop signal Stop5 is true), the timer 222 stops timing to generate the time difference (time difference information Td2) to the speed compensation circuit 230. The embodiment does not limit the specific implementation of the timer 222. For example, the timer 222 may include a conventional timer or other timers. The speed compensation circuit 230 adjusts the output speed of the DP signal stream Dout2 of the decoding circuit 210 based on the time difference information Td2.

In the embodiment shown in FIG. 5, the decoding circuit 210 includes a decoder 211, a buffer 212, a DP signal generator 213, and a clock generator 214. The input terminal of the decoder 211 is coupled to a first input terminal of the detection circuit 220. The decoder 211 receives and decodes the input data stream Din2 to generate a decoding result. The embodiment does not limit the specific implementation of the decoder 211. For example, assuming that the input data stream Din2 is a USB data stream, the decoder 211 includes a USB decoder. The USB decoder may include a conventional USB decoder or other USB decoders. The input terminal of the buffer 212 is coupled to the output terminal of the decoder 211 to receive and temporarily store the decoding result from the decoder 211.

The clock generator 214 generates a transmission clock CLK. The clock generator 214 adjusts the frequency of the transmission clock CLK based on the control of the speed compensation circuit 230. The embodiment does not limit the specific implementation of the clock generator 214. For example, the clock generator 214 may include a conventional clock generator or other clock generators. The input terminal of the DP signal generator 213 is coupled to the output terminal of the buffer 212. The output terminal of the DP signal generator 213 is coupled to a second input terminal of the detection circuit 220. The clock terminal of the DP signal generator 213 is coupled to the output terminal of the clock generator 214 to receive the transmission clock CLK. The embodiment does not limit the specific implementation of the DP signal generator 213. For example, the DP signal generator 213 may include a conventional DP signal generator or other DP signal generators. The DP signal generator 213 converts the decoding result obtained from the buffer 212 into the DP signal stream Dout2 based on the transmission clock CLK.

For example, in response to the speed compensation circuit 230 judging that the time difference (for example, the time difference Delta[1] shown in FIG. 4) between the input data stream Din2 and the DP signal stream Dout2 is greater than the reference time length, the speed compensation circuit 230 controls the clock generator 214 to increase the frequency of the transmission clock CLK to speed up the output speed of the DP signal stream Dout2 of the DP signal generator 213 (that is, speed up the output speed of the buffer 212). In response to the speed compensation circuit 230 judging that the time difference between the input data stream Din2 and the DP signal stream Dout2 is less than the reference time length, the speed compensation circuit 230 controls the clock generator 214 to reduce the frequency of the transmission clock CLK to slow down the output speed of the DP signal stream Dout2 of the DP signal generator 213 (that is, slow down the output speed of the buffer 212).

Although the disclosure has been disclosed in the above embodiments, the embodiments are not intended to limit the disclosure. Persons skilled in the art may make some changes and modifications without departing from the spirit and scope of the disclosure. Therefore, the protection scope of the disclosure shall be defined by the appended claims.

What is claimed is:

1. A DisplayPort conversion device, comprising:
a decoding circuit, receiving and decoding an input data stream to generate a DisplayPort signal stream;
a detection circuit, coupled to an input terminal of the decoding circuit to receive the input data stream and coupled to an output terminal of the decoding circuit to receive the DisplayPort signal stream, wherein the detection circuit detects a first target content in the input data stream, the detection circuit detects a second target content in the DisplayPort signal stream, and the detection circuit measures a time difference between the first target content and the second target content; and
a speed compensation circuit, coupled to the detection circuit to receive time difference information indicating the time difference, wherein the speed compensation circuit adjusts an output speed of the DisplayPort signal stream of the decoding circuit based on the time difference.

2. The DisplayPort conversion device according to claim 1, wherein the decoding circuit comprises:
a decoder, receiving and decoding the input data stream to generate a decoding result, wherein a first input terminal of the detection circuit is coupled to an input terminal of the decoder;
a buffer, having an input terminal coupled to an output terminal of the decoder to receive and temporarily store the decoding result;
a clock generator, generating a transmission clock, wherein the clock generator adjusts a frequency of the transmission clock based on control of the speed compensation circuit; and
a DisplayPort signal generator, having an input terminal coupled to an output terminal of the buffer, wherein a second input terminal of the detection circuit is coupled to an output terminal of the DisplayPort signal generator, a clock terminal of the DisplayPort signal generator is coupled to an output terminal of the clock generator to receive the transmission clock, and the DisplayPort signal generator converts the decoding result obtained from the buffer into the DisplayPort signal stream based on the transmission clock.

3. The DisplayPort conversion device according to claim 1, wherein the detection circuit comprises:
a first detector, coupled to the input terminal of the decoding circuit to receive the input data stream, wherein the first detector detects the first target content in the input data stream;
a second detector, coupled to the output terminal of the decoding circuit to receive the DisplayPort signal stream, wherein the second detector detects the second target content in the DisplayPort signal stream; and
a timer, coupled to the speed compensation circuit, the first detector, and the second detector, wherein the timer starts timing in response to the first detector detecting the first target content, and stops timing in response to the second detector detecting the second target content to generate the time difference to the speed compensation circuit.

4. The DisplayPort conversion device according to claim 1, wherein at least one of the first target content and the second target content comprises main stream attribute (MSA) data.

5. The DisplayPort conversion device according to claim 4, wherein at least one of the first target content and the second target content comprises a control code (also referred to as a K-code, wherein the K-code is a control code for indicating a start of a row on a link layer) in the main stream attribute data.

6. The DisplayPort conversion device according to claim 5, wherein at least one of the first target content and the second target content comprises a scrambler reset (SR) symbol in the control code.

7. The DisplayPort conversion device according to claim 1, wherein the speed compensation circuit compares the time difference with a reference time length to obtain a comparison result, and the speed compensation circuit adjusts the output speed of the DisplayPort signal stream of the decoding circuit in response to the comparison result.

8. The DisplayPort conversion device according to claim 7, wherein:
in response to the time difference being greater than the reference time length, the speed compensation circuit speeds up the output speed of the DisplayPort signal stream of the decoding circuit; and
in response to the time difference being less than the reference time length, the speed compensation circuit slows down the output speed of the DisplayPort signal stream of the decoding circuit.

9. The DisplayPort conversion device according to claim 7, wherein the reference time length comprises an accumulation cycle number of a buffer of the decoding circuit.

10. The DisplayPort conversion device according to claim 7, wherein the reference time length comprises an initial time difference generated in detection operations of the input data stream and the DisplayPort signal stream.

11. The DisplayPort conversion device according to claim 1, wherein the DisplayPort conversion device is a DisplayPort out adapter.

12. An operation method of a DisplayPort conversion device, comprising:
receiving and decoding an input data stream by a decoding circuit of the DisplayPort conversion device to generate a DisplayPort signal stream, wherein a detection circuit of the DisplayPort conversion device is coupled to an input terminal of the decoding circuit to receive the input data stream, the detection circuit is coupled to an output terminal of the decoding circuit to receive the DisplayPort signal stream, and a speed compensation circuit of the DisplayPort conversion device is coupled to the detection circuit to receive time difference information;
detecting a first target content in the input data stream by the detection circuit;
detecting a second target content in the DisplayPort signal stream by the detection circuit;
measuring a time difference between the first target content and the second target content by the detection circuit, wherein the time difference information indicates the time difference; and
adjusting an output speed of the DisplayPort signal stream of the decoding circuit based on the time difference by the speed compensation circuit.

13. The operation method according to claim 12, further comprising:
receiving and decoding the input data stream by a decoder of the decoding circuit to generate a decoding result, wherein a first input terminal of the detection circuit is coupled to an input terminal of the decoder, an input terminal of a buffer of the decoding circuit is coupled to an output terminal of the decoder to receive and temporarily store the decoding result, an input terminal of a DisplayPort signal generator of the decoding circuit is coupled to an output terminal of the buffer, and a second input terminal of the detection circuit is coupled to an output terminal of the DisplayPort signal generator;
generating a transmission clock by a clock generator of the decoding circuit, wherein a clock terminal of the DisplayPort signal generator is coupled to an output terminal of the clock generator to receive the transmission clock;
adjusting a frequency of the transmission clock based on control of the speed compensation circuit by the clock generator; and
converting the decoding result obtained from the buffer into the DisplayPort signal stream based on the transmission clock by the DisplayPort signal generator.

14. The operation method according to claim 12, further comprising:
detecting the first target content in the input data stream by a first detector of the detection circuit, wherein the first detector is coupled to the input terminal of the decoding circuit to receive the input data stream;
detecting the second target content in the DisplayPort signal stream by a second detector of the detection circuit, wherein the second detector is coupled to the output terminal of the decoding circuit to receive the DisplayPort signal stream;
in response to the first detector detecting the first target content, starting timing by a timer of the detection circuit, wherein the timer is coupled to the speed compensation circuit, the first detector, and the second detector; and
in response to the second detector detecting the second target content, stopping timing by the timer to generate the time difference to the speed compensation circuit.

15. The operation method according to claim 12, wherein at least one of the first target content and the second target content comprises main stream attribute data.

16. The operation method according to claim 15, wherein at least one of the first target content and the second target content comprises a control code in the main stream attribute data.

17. The operation method according to claim 16, wherein at least one of the first target content and the second target content comprises a scrambler reset symbol in the control code.

18. The operation method according to claim 12, further comprising:
comparing the time difference with a reference time length by the speed compensation circuit to obtain a comparison result; and
in response to the comparison result, adjusting the output speed of the DisplayPort signal stream of the decoding circuit by the speed compensation circuit.

19. The operation method according to claim 18, further comprising:
in response to the time difference being greater than the reference time length, speeding up the output speed of the DisplayPort signal stream of the decoding circuit; and
in response to the time difference being less than the reference time length, slowing down the output speed of the DisplayPort signal stream of the decoding circuit.

20. The operation method according to claim 18, wherein the reference time length comprises an accumulation cycle number of a buffer of the decoding circuit.

21. The operation method according to claim 18, wherein the reference time length comprises an initial time difference generated in detection operations of the input data stream and the DisplayPort signal stream.

22. The operation method according to claim 12, wherein the DisplayPort conversion device is a DisplayPort out adapter.
